(19) United States
(12) Patent Application Publication
(10) Pub. No.: US 2014/0369844 A1
(43) Pub. Date: Dec. 18, 2014

(54) OPTIMISATION OF THE BEARING POINTS OF THE STILTS OF VANES IN A METHOD FOR MACHINING SAID VANES

(71) Applicant: SNECMA, Paris (FR)

(72) Inventors: Michael Hansom, Paris (FR); Huu-Thanh Tran, Merignac (FR); Christian Bariaud, Orsay (FR)

(73) Assignee: SNECMA, Paris (FR)

(21) Appl. No.: 14/373,817

(22) PCT Filed: Jan. 24, 2013
(86) PCT No.: PCT/FR2013/050146

§ 371 Date: Jul. 22, 2014

(30) Foreign Application Priority Data
Feb. 2, 2012 (FR) 1251000

(51) Int. Cl. F01D 5/14; B23P 15/02

(52) U.S. Cl. CPC F01D 5/14; B23P 15/02
USPC 416/223 R; 29/889.7

(57) ABSTRACT

A method of machining a blade in a three-dimensional machining center, the blade including an airfoil, a platform including upstream and downstream supports formed respectively under the upstream and downstream portions thereof for supporting a sealing liner, a blade root, and a stilt interposed between the platform and the blade root, the method including the upstream and downstream supports constituting two bearing points for a six-point positioning system for positioning the blade in the three-dimensional machining center.

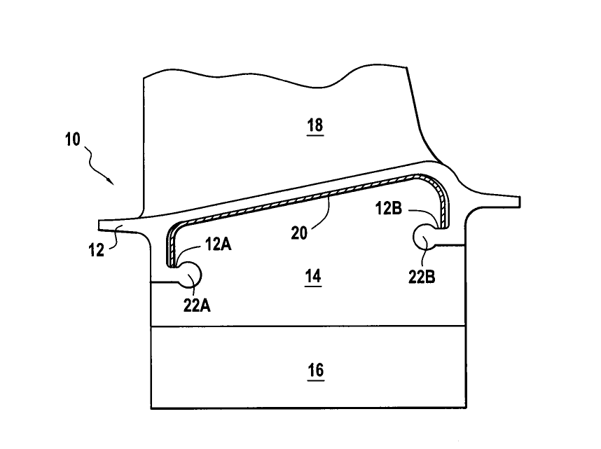

### BACKGROUND OF THE INVENTION

The present invention relates to the general field of gas turbines for airplane or helicopter engines and it relates more particularly to a method of fabricating blades, which method serves to minimize stresses and weight during machining.

In known manner, blades are parts that are particularly complex and for which fabrication using a foundry process is lengthy and expensive and found to be difficult, in particular because of the fabrication tolerances that are required.

Because of its dimensional tolerances that are of millimeter order and because of its surface state, a casing is rarely a part that can be used directly. It must therefore subsequently be machined at least in part (typically on a numerically controlled machining center), which makes it necessary to have recourse to a geometrical frame of reference that is specific to such machining. Unfortunately, in order to execute the machining operations, it is necessary to select a system for positioning the part in the machining center that is optimized and that guarantees the required accuracy while also being easy to inspect. The positioning system must also be statically determinate, i.e. it must enable the part to be positioned without ambiguity in three dimensions, generally using six bearing points that are suitably distributed, in particular in order to maximize the distances between them. Once the part has been machined, these bearing points remain and in practice they are not point-sized but rather spots of finite small dimensions, while nevertheless being small enough to approximate ideal points.

Unfortunately, the moving blades of turbines, for example, are generally of small dimensions, which makes it difficult to maximize the distances between the bearing points, particularly when the bearing points of non-zero size give rise to extra weight.

### OBJECT AND SUMMARY OF THE INVENTION

A main object of the present invention is thus to mitigate such drawbacks by proposing a method of machining blades that makes it possible in particular to minimize concentrations of mechanical stresses while also saving weight.

This object is achieved by a method of machining a blade in a three-dimensional machining center, the blade comprising an airfoil, a platform having upstream and downstream supports formed respectively under the upstream and downstream portions thereof for supporting a sealing liner, a blade root, and a stilt interposed between said platform and said blade root, the method being characterized in that said supports also constitute two bearing points for a six-point positioning system for positioning said blade in said three-dimensional machining center.

By limiting stress concentrations on the blade, this combination of the support function and of the bearing point function makes it possible to simplify the machining that is to be performed, and also to obtain the desired saving in weight.

According to an advantageous provision, said bearing points are formed on the suction side of said stilt.

The invention also provides a blade obtained by the method and a turbine engine including a plurality of blades as specified above.

### BRIEF DESCRIPTION OF THE DRAWING

Other characteristics and advantages of the present invention appear from the following description made with reference to the single accompanying FIGURE which shows an embodiment having no limiting character.

### DETAILED DESCRIPTION OF EMBODIMENTS

The sole FIGURE is an elevation view of a turbine engine blade 10, e.g. a fan blade, a turbine blade, or a compressor blade, that is fastened in known manner to the periphery of a rotor disk of the engine (not shown) and that typically comprises a blade root 16 of a Christmas tree or dovetail shape under a platform 12, and spaced apart therefrom by a stilt 14, which root is received in a corresponding slot or groove (not shown) in the periphery of the rotor disk.

The stilt 14 presents thickness that is small compared to the blade root 16 so as to pass through the opening defined by the slot and provide mechanical connection between the root and the aerodynamic portion (or airfoil 18) of the blade. Under the platform there are conventionally arranged both upstream and downstream supports 12A and 12B for a sealing liner 20, where “upstream” and “downstream” are relative to the stream of air passing between the blades.

In order to enable such a blade to be machined, it is necessary to define reference faces that are to be the starting faces for dimensioning the parts and bearing points that are to serve as reference points for the machining and for subsequent inspection of the part. Conventionally there are six bearing points distributed all around the part for machining, and they form portions of a six-point positioning system enabling the part to be machined in a three-dimensional machining center.

In the invention, the side face of the stilt 14 on the suction side is selected as a reference face and the upstream and downstream supports of the sealing liner are also used as bearing points 22A, 22B for the six-point positioning system for positioning the blade in the three-dimensional machining center, the other four bearing points being distributed on the other faces of the blade. With this configuration, these two bearing points are relatively close to the edges of the stilt, thereby maximizing the spacing between them. The concentration of stresses that results from the large number of small radii of curvature already present at the roots of the bearing points for the sealing liner 20 are thus not increased because these radii of curvature are grouped together with those that result from the bearing points, and the overall weight of the blade is also reduced because of the fact that the support and bearing functions that are combined at these two points coincide.

1-4. (canceled)

5. A method of machining a blade in a three-dimensional machining center, the blade comprising an airfoil, a platform including upstream and downstream supports formed respectively under the upstream and downstream portions thereof for supporting a sealing liner, a blade root, and a stilt interposed between the platform and the blade root, the method comprising:
the upstream and downstream supports constituting two bearing points for a six-point positioning system for positioning the blade in the three-dimensional machining center.

6. A machining method according to claim 5, wherein the bearing points are formed on a suction side of the stilt.

7. A turbine engine including a plurality of blades obtained by the machining method of claim 5.

8. A turbine engine including a plurality of blades obtained by the machining method of claim 6.
